(19) United States
(12) Patent Application Publication
(10) Pub. No.: US 2015/0307030 A1
(43) Pub. Date: Oct. 29, 2015

(54) No-slide handbag holder for vehicle's console

(71) Applicant: Angela Locascio, Old Forge, PA (US)

(72) Inventor: Angela Locascio, Old Forge, PA (US)

(21) Appl. No.: 14/544,836

(22) Filed: Feb. 23, 2015

Related U.S. Application Data
(60) Provisional application No. 61/996,088, filed on Apr. 29, 2014.

(51) Int. Cl. B60R 7/04; B60R 7/08

(52) U.S. Cl. CPC B60R 7/04; B60R 7/087; B60R 2011/0007

(57) ABSTRACT

The front has a slight dip in a V shape for design purposes. It is made of a folding carton (cardboard box) that is covered in a durable vinyl resembling leather, and the color can be matched to the vehicle's interior, or console. The back design has a fold on each side resembling a pleat. Two clear double-sided tapes are centered, and affixed to the bottom of the holder that adhere to the console.

Claims reference to Provisional Patent application Ser. No. 61/996,088 filed on Apr. 29, 2014.

### BACKGROUND INFORMATION

It mounts on your vehicle's console, and does not interfere with any glass holders in front or behind it. Whether your console lifts up, or to the side to reveal storage, not to worry, the holder and handbag will lift with it, and will not slip off the console to end up in the back area of your vehicle. You can remove the handbag holder without ruining your console. The double-sided tape does not leave a heavy residue, and whatever little residue it may leave is easily wiped off. Therefore, it is transportable to another vehicle if one chooses, and the tape holds a heavy handbag and the holder in place.

In summary, you have easy access to your handbag, if necessary. If you make a sudden stop, you don't have to worry about the handbag falling off the passenger seat and getting dirty. Also, if your handbag is wet from rain or snow, the passenger seat will not get wet. In addition, if you have a passenger, you won't be crowding the passenger with your handbag.

Photographs, & Drawing enclosed consisting of:

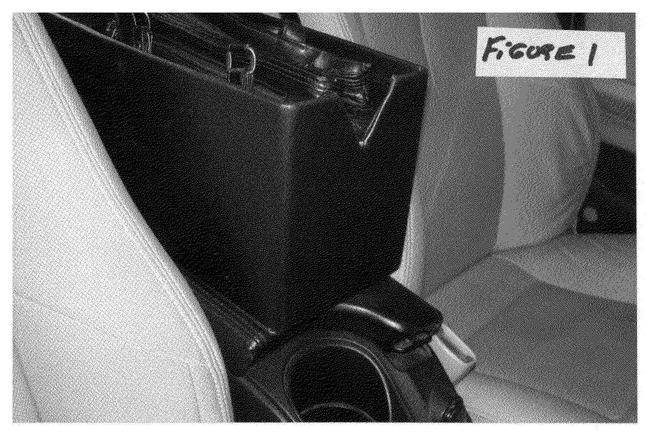

FIG. 1—Front view of the No-Slide Handbag Holder.

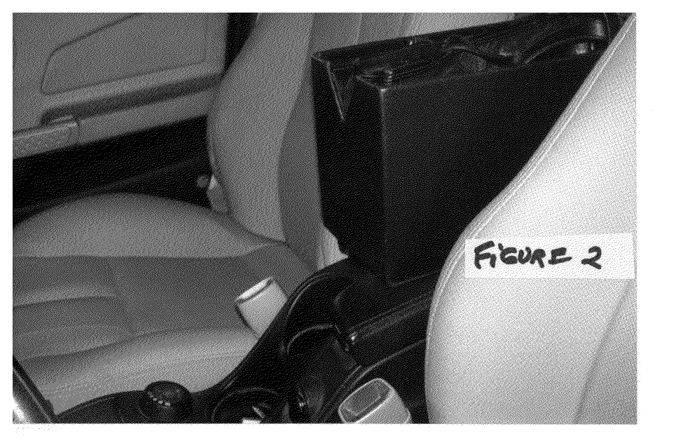

FIG. 2—Is a left side view thereof. Right side is a mirror image.

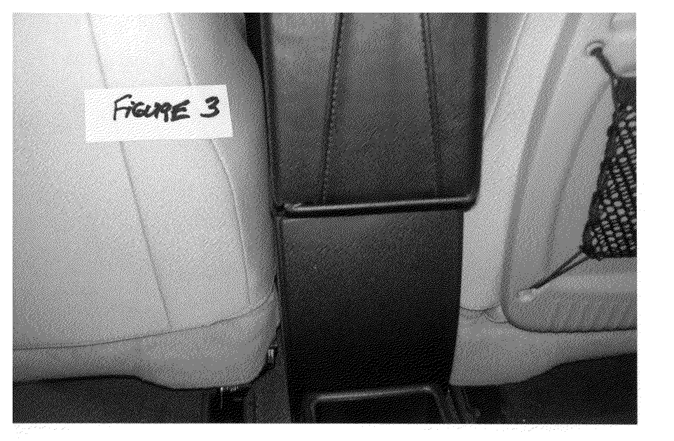

FIG. 3—Is a rear view thereof.

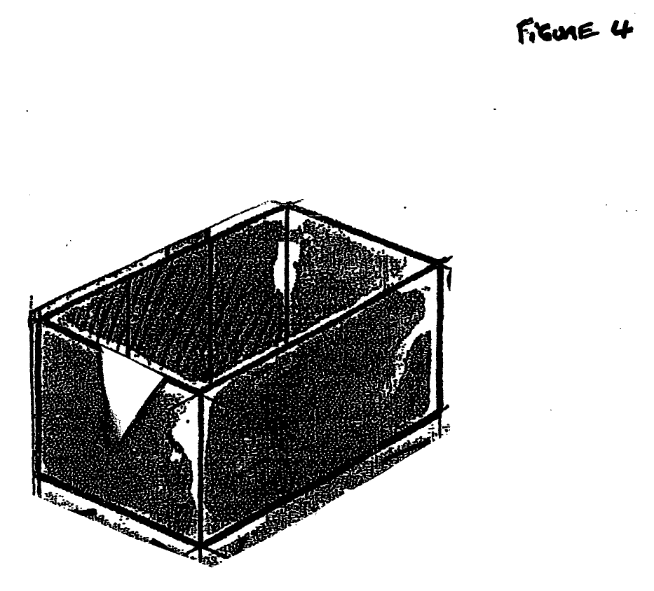

FIG. 4—Drawing

1. I like to put my handbag on top of my console instead of the passenger's seat for various reasons. If I put it on the seat, and I had to stop in a hurry, it went flying on the floor. Also, my car seats are rag interior and light in color. The handbag's bottom would pick up dirt from putting it down in other areas, and if you put it on the car seat, it would dirty the interior. Also, if you have a passenger, you would crowd the passenger by putting it on the passenger seat. In addition, the handbag was not easily accessible if you needed something in a hurry. However, if you have a passenger sitting next to you, and it has happened to me, and they move their elbow over, he/she would knock my purse off the console. I also was not able to get at anything stored underneath if I needed it. Therefore, my idea and invention were born.
